(19) United States
(12) Patent Application Publication
(10) Pub. No.: US 2026/0093341 A1
(43) Pub. Date: Apr. 2, 2026

(54) ELECTRONIC APPARATUS AND CONTROLLING METHOD THEREOF

(71) Applicant: SAMSUNG ELECTRONICS CO., LTD., Suwon-si (KR)

(72) Inventors: Dogyun KIM, Suwon-si (KR); Minkyo SEO, Suwon-si (KR); Kyuhyun CHO, Suwon-si (KR)

(73) Assignee: SAMSUNG ELECTRONICS CO., LTD., Suwon-si (KR)

(21) Appl. No.: 19/350,728

(22) Filed: Oct. 6, 2025

Related U.S. Application Data
(63) Continuation of application No. PCT/KR2025/010214, filed on Jul. 11, 2025.

(30) Foreign Application Priority Data
Oct. 2, 2024 (KR) 10-2024-0134267

(51) Int. Cl. G06F 3/01; A63F 13/213; G06F 3/0346; G06F 3/038; G06T 7/70; G06V 40/10; G06V 40/20; H04N 21/422

(52) U.S. Cl. CPC G06F 3/017; A63F 13/213; G06F 3/011; G06F 3/0346; G06F 3/0383; G06T 7/70; G06V 40/10; G06V 40/28; G06F 2203/0384; G06T 2207/30196; H04N 21/42221

(57) ABSTRACT

An electronic apparatus may include: a sensor; a communicator configured to receive an Ultra Wide-Band (UWB) signal; memory storing at least one instruction; and at least one processor operatively connected to the sensor, the communicator, and the memory, wherein the at least one instruction, when executed by the at least one processor individually or collectively, causes the electronic apparatus to: obtain a first candidate location corresponding to a location of an external device, based on the UWB signal received by the communicator; based on a first image obtained through the sensor, obtain a second candidate location corresponding to at least one body part in the first image; obtain location information of a user body part of a user corresponding to the external device based on the first candidate location and the second candidate location; and generate a second image based on the location information.

### CROSS-REFERENCE TO RELATED APPLICATIONS

This application is a continuation application is a continuation application, under 35 U.S.C. § 111(a), of international application No. PCT/KR2025/010214, filed on Jul. 11, 2025, which claims priority under 35 U.S.C. § 119 to Korean Patent Application No. 10-2024-0134267, filed on Oct. 2, 2024, the disclosures of which are incorporated herein by reference in their entireties.

### BACKGROUND

### 1. Field

The present disclosure relates to an electronic apparatus that may detect a gesture of a user by using location information using an Ultra Wide-Band (UWB) signal together with object recognition information using a captured image, and a controlling method thereof.

### 2. Related Art

An electronic apparatus may generate an image corresponding to content or perform an operation of displaying an image. A recent electronic apparatus may receive control commands not only directly through buttons and the like, but also through various methods and gestures.

### SUMMARY

Embodiments of the present disclosure may solve at least one of the above-described problems and/or disadvantages and provide advantages to be described below.

Provided are an electronic apparatus that may detect a user's gesture by using location information using both a UWB signal and object recognition information using a captured image, and a controlling method thereof.

Additional aspects will be set forth in part in the description which follows and, in part, will be apparent from the description, or may be learned by practice of the presented embodiments.

According to an aspect of the disclosure, an electronic apparatus may include: a sensor; a communicator configured to receive an Ultra Wide-Band (UWB) signal; memory storing at least one instruction; and at least one processor operatively connected to the sensor, the communicator, and the memory, wherein the at least one instruction, when executed by the at least one processor individually or collectively, causes the electronic apparatus to: obtain a first candidate location corresponding to a location of an external device, based on the UWB signal received by the communicator; based on a first image obtained through the sensor, obtain a second candidate location corresponding to at least one body part in the first image; obtain location information of a user body part of a user corresponding to the external device based on the first candidate location and the second candidate location; and generate a second image based on the location information.

The at least one instruction, when executed by the at least one processor individually or collectively, may further cause the electronic apparatus to: recognize a first hand and a second hand of a user as the at least one body part in the first image; and obtain the second candidate location by identifying a hand that grips the external device among the first hand and the second hand, based on the first candidate location.

A first object may be displayed at a location corresponding to the first hand and a second object different from the first object is displayed at a location corresponding to the second hand in the second image.

The at least one instruction, when executed by the at least one processor individually or collectively, may further cause the electronic apparatus to, based on recognizing a plurality of users based on the first image, identify a user gripping the external device among the plurality of users based on the first candidate location, and obtain the second candidate location based on the hand that grips the external device.

The at least one instruction, when executed by the at least one processor individually or collectively, may further cause the electronic apparatus to: store the location information and time information in the memory; and identify the user body part based on the location information stored in the memory, and obtain the second candidate location based on the user body part.

The at least one instruction, when executed by the at least one processor individually or collectively, may further cause the electronic apparatus to: compare the location information stored in the memory and the first candidate location; and based on the first candidate location and a location corresponding to the stored location information being equal to or greater than a preset distance, obtain the first candidate location based on the location information stored in the memory.

The at least one instruction, when executed by the at least one processor individually or collectively, may further cause the electronic apparatus to, based on a reception period of the first image being shorter than a reception period of the UWB signal from the external device, obtain the first candidate location corresponding to a current time point based on the location information stored in the memory and a most recently obtained first candidate location.

The at least one instruction, when executed by the at least one processor individually or collectively, may further cause the electronic apparatus to: identify a user gesture based on the location information stored in the memory and the location information that is obtained; and perform an event corresponding to the user gesture.

The at least one instruction, when executed by the at least one processor individually or collectively, may further cause the electronic apparatus to: obtain a user pose based on the first image; and obtain the location information based on the user pose and the first candidate location.

The at least one instruction, when executed by the at least one processor individually or collectively, may further cause the electronic apparatus to identify whether the first candidate location is within the first image, and obtain the second candidate location based on whether the first candidate location is within the first image.

According to an aspect of the disclosure, a method of controlling an electronic apparatus, may include: obtaining, based on an Ultra Wide-Band (UWB) signal received from an external device, a first candidate location corresponding to a location of the external device; obtaining a second candidate location corresponding to at least one body part in a first image; obtaining location information of a user body corresponding to the external device based on the first candidate location and the second candidate location; and generating a second image based on the location information.

The obtaining the second candidate location may include recognizing a first hand and a second hand of a user as the at least one body part in the first image, and obtaining the second candidate location by identifying a hand that grips the external device among the first hand and the second hand, based on the first candidate location.

A first object may be displayed at a location corresponding to the first hand and a second object different from the first object is displayed at a location corresponding to the second hand in the second image.

The obtaining the second candidate location may include, based on recognizing a plurality of users based on the first image, identifying a user gripping the external device among the plurality of users based on the first candidate location, and obtaining the second candidate location based on the hand that grips the external device.

The method may further include: storing the location information and time information in the memory; and identifying the user body part based on the stored location information, and obtaining the second candidate location based on the user body part.

The method may further include: comparing the stored location information and the first candidate location; and based on the first candidate location and a location corresponding to the stored location information being equal to or greater than a preset distance, obtaining the first candidate location based on the stored location information.

The method may further include: based on a reception period of the first image being shorter than a reception period of the UWB signal from the external device, obtaining the first candidate location corresponding to a current time point based on the stored location information and a most recently obtained first candidate location.

The method may further include: identifying a user gesture based on the stored location information and the location information; and performing an event corresponding to the user gesture.

The method may further include: obtaining a user pose based on the first image; and obtaining the location information based on the user pose and the first candidate location.

According to an aspect of the disclosure, a non-transitory computer recording medium storing a program for executing a method of controlling an electronic apparatus, the method may include: obtaining, based on an Ultra Wide-Band (UWB) signal received from an external device, a first candidate location corresponding to a location of the external device; obtaining a second candidate location corresponding to at least one body part in a first image; obtaining location information of a user body part corresponding to the external device based on the first candidate location and the second candidate location; and generating a second image based on the location information.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a view provided to explain a gesture recognition method according to one or more embodiments;

FIG. 2 is a block diagram of a configuration of an electronic apparatus according to one or more embodiments;

FIG. 3 is a block diagram of a configuration of an electronic apparatus according to one or more embodiments;

FIG. 4 is a view provided to explain a method of obtaining a location using both a UWB signal and object recognition information according to one or more embodiments;

FIG. 5 is a view provided to explain an operation for identifying left/right hands of a user according to one or more embodiments;

FIG. 6 is a view provided to explain an operation for identifying a user to perform object recognition among a plurality of users according to one or more embodiments;

FIG. 7 is a diagram of a UWB positioning operation according to one or more embodiments; and

FIG. 8 is a flowchart of a controlling method of an electronic apparatus according to one or more embodiments.

### DETAILED DESCRIPTION

The embodiments of the present disclosure may be modified in various ways, and may have various embodiments, so specific embodiments are illustrated in the drawings and described in detail in the detailed description. However, it is to be understood that the disclosure is not limited to specific example embodiments, but include all modifications, equivalents, and/or alternatives according to example embodiments of the disclosure. Throughout the description of the accompanying drawings, similar components may be denoted by similar reference numerals.

In describing the disclosure, when it is decided that a detailed description for the known functions or configurations related to the disclosure may unnecessarily obscure the gist of the disclosure, the detailed description therefor will be omitted.

In addition, the following example embodiments may be modified in several different forms, and the scope of the technical spirit of the disclosure is not limited to the following example embodiments. Rather, these example embodiments make the disclosure thorough and complete, and are provided to completely transfer the spirit of the disclosure to those skilled in the art.

Terms used in the disclosure are used only to describe specific example embodiments rather than limiting the scope of the disclosure. Singular forms are intended to include plural forms unless the context clearly indicates otherwise.

In the disclosure, the expressions “have”, “may have”, “include” or “may include” used herein indicate existence of corresponding features (e.g., elements such as numeric values, functions, operations, or components), but do not exclude presence of additional features.

In the disclosure, the expressions “A or B”, “at least one of A or B”, or “one or more of A or/and B”, and the like may include any and all combinations of one or more of the items listed together. For example, herein, the expression, “at least one of A, B, and C,” should be understood as including only A, only B, only C, both A and B, both A and C, both B and C, or all of A, B, and C.

Expressions “first”, “second”, “1st,” “2nd,” or the like, used in the disclosure may indicate various components regardless of sequence and/or importance of the components, will be used only in order to distinguish one component from the other components, and do not limit the corresponding components.

When it is described that an element (e.g., a first element) is referred to as being “(operatively or communicatively) coupled with/to” or “connected to” another element (e.g., a second element), it should be understood that it may be directly coupled with/to or connected to the other element, or they may be coupled with/to or connected to each other through an intervening element (e.g., a third element).

On the other hand, when an element (e.g., a first element) is referred to as being “directly coupled with/to” or “directly connected to” another element (e.g., a second element), it should be understood that there is no intervening element (e.g., a third element) in-between.

An expression “˜configured (or set) to” used in the disclosure may be replaced by an expression, for example, “suitable for,” “having the capacity to,” “˜designed to,” “˜adapted to,” “˜made to,” or “˜capable of” depending on a situation. A term “˜configured (or set) to”may not necessarily mean “specifically designed to”in hardware.

Instead, an expression “˜an apparatus configured to” may mean that an apparatus “is capable of” together with other apparatuses or components. For example, a “processor configured (or set) to perform A, B, and C” may mean a dedicated processor (e.g., an embedded processor) for performing the corresponding operations or a generic-purpose processor (e.g., a central processing unit (CPU) or an application processor) that may perform the corresponding operations by executing one or more software programs stored in a memory device.

In example embodiments, a ‘module’ or a ‘unit’ may perform at least one function or operation, and be implemented as hardware or software or be implemented as a combination of hardware and software. In addition, a plurality of ‘modules’ or a plurality of ‘units’may be integrated into at least one module and be implemented as at least one processor except for a ‘module’ or a ‘unit’ that needs to be implemented as specific hardware.

Operations performed by the modules, the programs, or other components according to the various embodiments may be executed in a sequential manner, a parallel manner, an iterative manner, or a heuristic manner, or at least some of the operations may be performed in a different order or be omitted, or other operations may be added.

Various elements and regions in the drawings are schematically drawn in the drawings. Therefore, the technical concept of the disclosure is not limited by a relative size or spacing drawn in the accompanying drawings.

The electronic apparatus according to various embodiments may include at least one of, for example, a smart phone, a tablet PC, a desktop PC, a laptop server or a wearable device. The wearable device may include at least one of an accessory type of a device (e.g., a timepiece, a ring, a bracelet, an anklet, a necklace, glasses, a contact lens, or a head-mounted-device (HMD)), one-piece fabric or clothes type of a circuit (e.g., electronic clothes), a body-attached type of a circuit (e.g., a skin pad or a tattoo), or a bio-implantable type of a circuit.

According to some embodiments, the electronic apparatus may include at least one of televisions (TVs), digital versatile disc (DVD) players, audios, refrigerators, air-conditioners, cleaners, ovens, microwave ovens, washing machines, air cleaners, set-top boxes, home automation control panels, security control panels, media boxes (e.g., Samsung HomeSync™, Apple TV™, or Google TV™), game consoles (e.g., Xbox™ or PlayStation™), electronic dictionaries, electronic keys, camcorders, electronic picture frames, or the like. Among the above-mentioned electronic apparatuses, a device equipped with a display may be referred to as a display device. The electronic apparatus of the present disclosure may be a set-top box or a PC that provides images to a display device, even if it does not have a display.

Hereinafter, one or more embodiments according to the present disclosure will be described in detail with reference to the accompanying drawings so that a person with ordinary knowledge in the technical field to which the present disclosure belongs can easily implement the present disclosure.

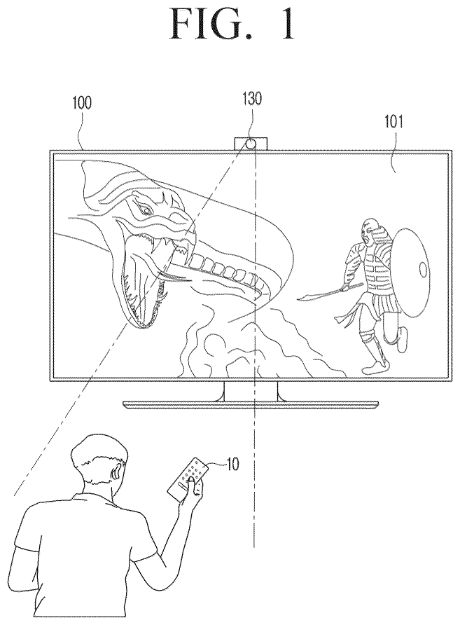

FIG. 1 is a view provided to explain an operation of an electronic apparatus according to one or more embodiments.

Referring to FIG. 1, an electronic apparatus 100 may photograph a user positioned in front and display an image 101 corresponding to the user's movement in the photographed image. For example, when the user moves his or her right hand, the electronic apparatus 100 may generate an image in which a specific object (e.g., a shield) moves in response to the movement of the user's right hand.

In addition, the electronic apparatus 100 may not only display an object in response to the movement of a body part of the user (e.g., right hand or left hand), but may also recognize the user's gesture corresponding to the movement.

Here, the user's gesture may include a motion (e.g., movement) of a specific area (e.g., wrist, palm, etc.) in the user's body. The user's gesture is not limited thereto, and the user's gesture may include a tap operation, a double tap operation, a swipe operation, a flick operation, a pinch-in/out operation, a rotation operation, and the like of a specific area.

A gesture recognition method using a captured image as described above has several limitations. For example, when a body part used for recognition is not captured (for example, when it is covered by another body part or the user turns his or her back on the electronic apparatus), when the movement of a specific body part is not large, when the lighting is dark, or when the color difference between the body and the background is not large, it is difficult to recognize the body area described above, and accordingly, it is difficult to properly recognize or display an object.

In addition, when there are multiple users in front of the electronic apparatus, it is necessary to specify a user to be used for object recognition.

In order to solve the above-described problems, the present disclosure recognizes the location of the user's body area by using a UWB signal transmitted from another electronic apparatus (or external device) supporting UWB communication. The other electronic apparatus may be a remote controller supporting a UWB communication scheme or a user terminal device.

Here, the body area may be a left hand or a right hand that may hold an external device, but is not limited thereto. In other words, the present disclosure may be applied to not only a case where the user directly grips a UWB device, but also a case where it is attached to a body part area using a binding device or the like.

In addition, although the present disclosure assumes that it is applied to humans, it may also be applied to animals or robots when implemented.

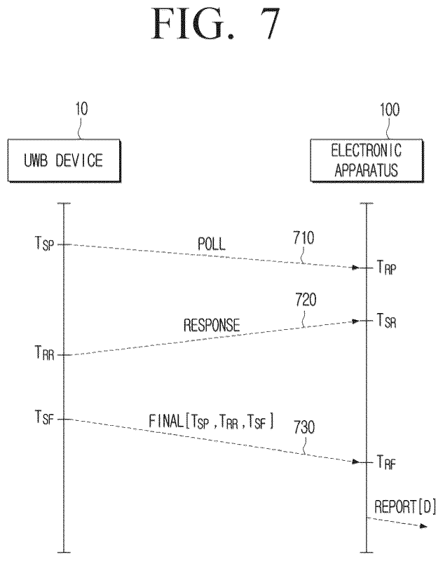

Here, Ultra-Wideband (UWB) communication is a short-range RF technology for wireless communication that can detect the location of people, devices, and assets with excellent accuracy and, like other communication protocols such as Bluetooth and Wi-Fi, can transmit data between devices over radio wavelengths. Such UWB communication uses short nanosecond pulses to perform communication at frequencies in the “ultra-wide” range. The positioning operation using UWB communication will be described below with reference to FIG. 7.

Therefore, when the user holds a UWB device 10 supporting UWB communication and makes a gesture, the location information using the UWB signal and the object recognition result using the image may be combined to identify the location of the user's body part.

Subsequently, the electronic apparatus may display an object or recognize the user's gesture based on the identified location.

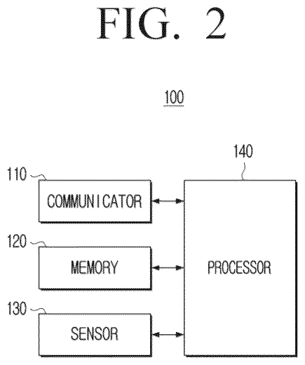

The detailed configuration and operation of the electronic apparatus 100 of the present disclosure will be described below with reference to FIG. 2.

As described above, the electronic apparatus according to the present disclosure may determine the location of the user's body part by using not only the analysis of the obtained image but also the location information obtained by the UWB communication scheme, and thus a more accurate operation is possible.

In FIG. 1, for convenience of explanation, it is assumed that the electronic apparatus directly displays an image, but when implemented, the electronic apparatus may be a device that outputs an image without having a display.

FIG. 1 illustrates one or more embodiments in which an object in an image moves in response to a user's gesture, but when implemented, the user's gesture may not cause a change in the image and may only change the operation state of the electronic apparatus. For example, when the user's gesture is volume control or mute, the above-described setting may be changed in response to the user's gesture.

In addition, when implemented, an indicator may be displayed on the image, and it is also possible to move the indicator in response to the user's hand motion.

FIG. 2 is a block diagram of a configuration of an electronic apparatus according to one or more embodiments.

Referring to FIG. 2, the electronic apparatus 100 may include a communicator 110, memory 120, a sensor 130, and at least one processor 140.

The communicator 110 is configured to perform communication with various types of external devices according to various types of communication schemes. The communicator 110 includes a UWB module, and may further include a wired communication module, a Wi-Fi module, a Bluetooth module, an infrared communication module, a wireless communication module, and the like. Here, each communication module may include at least one hardware chip or hardware circuit.

The UWB module may perform communication with other devices (e.g., a remote controller, a user terminal device) in a UWB scheme. The Wi-Fi module and the Bluetooth module may perform communication in a Wi-Fi method and a Bluetooth method, respectively. When using a Wi-Fi module or a Bluetooth module, various connection information such as SSID and session keys are first transmitted and received, and various information can be transmitted and received after establishing communication connection using this.

The infrared communication module performs communication according to an infrared Data Association (IrDA) communication technology which transmits data wirelessly over a short distance using infrared rays between optical light and millimeter waves.

The wireless communication module includes at least one communication chip that performs communication according to various wireless communication standards, such as Zigbee, 3rd Generation (3G), 3rd Generation Partnership Project (3GPP), Long Term Evolution (LTE), LTE advanced (LTE-A), 4th Generation (4G), 5th Generation (5G), etc. in addition to the above-described communication schemes.

The communicator 110 may further include a Local Area Network (LAN) module, an Ethernet module, a wired communication module that performs communication using a pair cable, a coaxial cable or an optical fiber cable, and the like.

The communicator 110 may receive location information (or time information) from a UWB device. Specifically, the communicator 110 may transmit and receive a series of messages for obtaining location information to and from the UWB device. Here, the messages may be a poll message, a response message, or a final message to be described below with reference to FIG. 7.

The communicator 110 may obtain content related to an image generated by the electronic apparatus. Here, the content may be film, music, play, photo, carton, animation, computer game, web page, text, figure, color, voice, movement or picture, or a combination of the above.

The memory 120 may be implemented as internal memory such as ROM (e.g., electrically erasable programmable read-only memory (EEPROM)), RAM, etc. included in the processor 140 or memory separate from the processor 140. In this case, the memory may be implemented in the form of memory embedded in the electronic apparatus 100 or in the form of memory detachable from the electronic apparatus 100 depending on the data storage purpose. For example, in the case of data for driving the electronic apparatus 100, the data may be stored in the memory embedded in the electronic apparatus 100, and in the case of data for the expansion function of the electronic apparatus 100, the data may be stored in the memory detachable from the electronic apparatus 100.

The memory 120 may store location information obtained in the above process or may store an image obtained by a sensor to be described below.

The memory embedded in the electronic apparatus 100 may be implemented as at least one of a volatile memory (e.g. a dynamic RAM (DRAM), a static RAM (SRAM), or a synchronous dynamic RAM (SDRAM)), or a non-volatile memory (e.g., a one-time programmable ROM (OTPROM), a programmable ROM (PROM), an erasable and programmable ROM (EPROM), an electrically erasable and programmable ROM (EEPROM), a mask ROM, a flash ROM, a flash memory (e.g. a NAND flash or a NOR flash), a hard drive, or a solid state drive (SSD)). The memory detachable from the electronic apparatus 100 may be implemented in the form of a memory card (e.g., a compact flash (CF), a secure digital (SD), a micro secure digital (Micro-SD), a mini secure digital (Mini-SD), an extreme digital (xD), or a multi-media card (MMC)), an external memory connectable to a USB port (e.g., a USB memory), or the like.

In the illustrated embodiment, the electronic apparatus 100 is depicted as consisting of one memory, but when referring to volatile memory and non-volatile memory separately, the electronic apparatus 100 may be described as including multiple memories.

The sensor 130 may detect a user located in the vicinity (for example, at least one of the front, back, or side) of the electronic apparatus 100. For example, the sensor 130 may be implemented as a camera, and the camera may capture a still image at a specific time point or may capture still images continuously.

Here, the camera may obtain a color image and a depth image. However, this is only an example, and the sensor 130 may be implemented as a time-of-flight (ToF) sensor, a lidar sensor, a radar sensor, an ultrasonic sensor, an infrared sensor, or the like. For example, the infrared sensor may detect infrared information to recognize a user.

The at least one processor 140 may perform the overall control operations of the electronic apparatus 100. The at least one processor 140 may be implemented as at least one of a digital signal processor (DSP) for processing digital signals, a microprocessor, or a time controller (TCON). However, the processor 140 is not limited thereto, and the processor 140 may include one or more of a central processing unit (CPU), a micro controller unit (MCU), a micro processing unit (MPU), a controller, an application processor (AP), a graphics-processing unit (GPU) or a communication processor (CP), and an ARM processor, or may be defined as the corresponding term. Further, the processor 140 may be implemented as a system on chip (SoC) with embedded processing algorithms, a large scale integration (LSI), or in the form of a field programmable gate array (FPGA). In addition, the processor 140 may perform various functions by executing computer executable instructions stored in the memory. Although FIG. 2 illustrates that only one processor is included in the electronic apparatus 100, a plurality of processors (e.g., CPU+GPU, CPU+DSP) may be included when implemented.

When a user control command is input, the processor 140 may generate an image corresponding to the input control command. Such a control command may be a selection of a specific button, a voice command, or a gesture based on the user's body use.

In order to receive such a gesture command, the processor 140 may receive an image from the sensor 130, and identify the location of a body part using the input image.

For such an operation, the processor 140 may first identify a user located around the electronic apparatus 100 based on the image received from the sensor 130. When a plurality of users are included in the image, the processor 140 may identify a user to perform object recognition based on a candidate location obtained through a UWB signal or location information obtained in a previous step.

Subsequently, the processor 140 may recognize the location of the user's body part area identified in the image received in real time through the sensor 130. For example, the processor 140 may recognize a body part such as the user's face, hand, arm, and leg from the image received in real time through the sensor 130, and track the movement of the recognized body part.

The processor 140 obtains a second candidate location corresponding to a preset object in the image based on the received image. For example, the processor 140 may identify the user's body in the corresponding image. Here, the body part may be a face, a hand, an arm, a leg, or the like, but hereinafter, it will be described on the assumption that the body part is a left hand or a right hand. A vision model or a neural network model such as a face recognition model or a hand recognition model may be used for the recognition of a preset object.

Such a neural network model may be referred to as a neural model, an AI model, a learning model, and the like. Such a neural network model is a computer system that implements human-level intelligence, allowing the machine to learn and make judgments on its own, and the recognition rate improves with use.

The location information obtained in this process may be an absolute location (or an absolute coordinate, X, Y, and Z coordinate) in a specific space, or may be relative location information based on the location identified in the previous step.

Accordingly, the processor 140 may recognize the first hand and the second hand of the user in the image based on the image, and may obtain the second candidate location by identifying the hand holding the UWB device among the first hand or the second hand based on the first candidate location. Although it is described above that the left or right hand is used, the foot may be used in the implementation, and the detailed configuration of the hand such as a specific finger or the back of the hand may be identified and used.

The processor 140 obtains the first candidate location corresponding to the location of the UWB device based on the signal received from the UWB device in an Ultra Wide-Band (UWB) scheme. For example, the processor 140 may obtain distance (or location) information of the UWB device supporting UWB communication using a UWB scheme (or TWR location tracking technology). The location information obtained here may not be an absolute location for the UWB device, but may be information about the direction and distance of the UWB device relative to the electronic apparatus.

As such, when both location information using a communication scheme and location information using object recognition are all obtained, the processor 140 obtains location information of the user's body holding the UWB device. For example, the processor 140 may use the first candidate location for location information and use image information for information on the user's body part for the corresponding location.

Subsequently, the processor 140 may store the obtained location information in the memory 120. The stored location information may be used in a verification process in a next frame. For example, the processor 140 may compare the location information obtained in the previous step with the first candidate location obtained in the current step to determine whether the location corresponding to the first candidate location and the stored location information is equal to or greater than a preset distance. When the distance is equal to or greater than the distance, the processor 140 may use pre-stored location information without using location information at the current stage.

In the above-described process, when one of the two information is not obtained or the update time of the two information is different, the processor 140 may predict one of the two information using pre-stored information and use the predicted information.

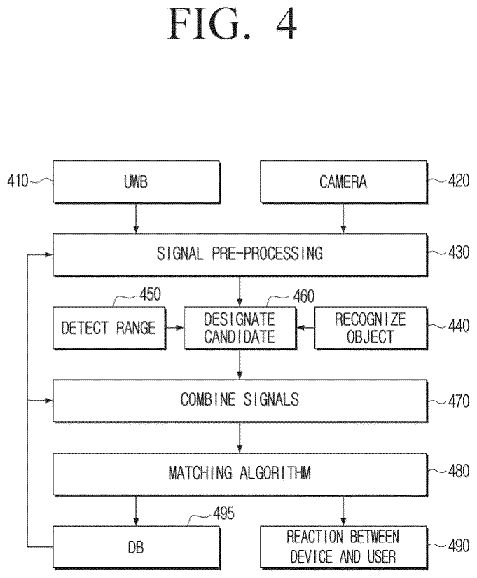

For example, when the reception period of the image is shorter than the signal reception period from the UWB device, the processor 140 may obtain the first candidate location corresponding to the current time based on the stored location information and a most recently obtained first candidate location. The operation of the processor 140 will be described below with reference to FIG. 4.

The processor 140 generates an image based on the obtained location information. For example, when the location of the first hand holding the UWB device and the second hand not holding the UWB device are respectively obtained, the processor 140 may generate an image in which a first object is displayed at the first hand location and a second object different from the first object is displayed at the second hand location.

Alternatively, the processor 140 may identify a user's gesture based on the above-described location information, and perform an event corresponding to the identified user's gesture. Such an event may be changing a specific setting of the electronic apparatus, displaying a specific object, or outputting a specific sound.

As described above, the electronic apparatus according to the present disclosure identifies the user's body area by using a UWB signal and an image together, so that even when it is difficult to identify an accurate movement using the image alone, confirming the accurate movement confirmation is possible.

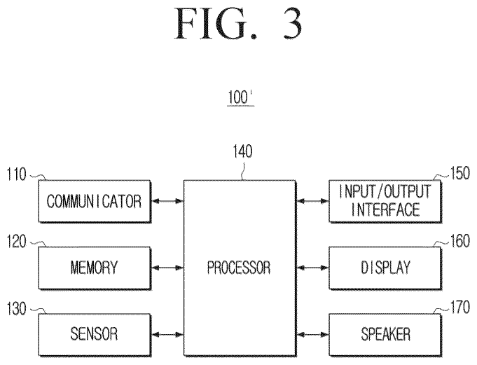

In the above, only simple configuration of the electronic apparatus 100 has been illustrated and described, but various configuration may be additionally provided at the time of implementation. This will be described below with reference to FIG. 3.

FIG. 3 is a block diagram of a configuration of an electronic apparatus according to one or more embodiments.

Referring to FIG. 3, an electronic apparatus 100′ may include the communicator 110, the memory 120, the sensor 130, the processor 140, an input/output interface 150, a display 160, and a speaker 170.

The configuration of the communicator 110, the memory 120, the sensor 130, and the processor 140 have been described above with reference to FIG. 2, so only operations different from those of FIG. 2 will be described below.

The input/output interface 150 may be one interface among a High Definition Multimedia Interface (HDMI), a Mobile High-Definition Link (MHL), a Universal Serial Bus (USB), a Display Port (DP), a Thunderbolt (BGA), a Video Graphics Array (VGA), an RGB port, a D-subminiature (D-SUB), and a Digital Visual Interface (DVI).

The input/output interface 150 may input/output at least one of an audio signal or a video signal. According to an implementation, the input/output interface 150 may include a port for inputting/outputting only an audio signal and a port for inputting/outputting only a video signal as separate ports, or may be implemented as one port for inputting/outputting both an audio signal and a video signal.

In addition, the input/output interface 150 may provide a video signal corresponding to the screen generated by the electronic apparatus 100′ or an audio signal together with the corresponding video signal to an external device (e.g., a display device, set top box (STB), etc.)

The input/output interface 150 may receive an image obtained by photographing a user. Although FIG. 2 describes obtaining an image photographing a user through a sensor inside the electronic apparatus 100, the photographed image may be obtained from a camera located outside the electronic apparatus when implemented. Such a photographed image may be obtained through the input/output interface 150, or may be obtained through the communicator 110. In addition, it is possible to use the image of both the internal camera and the external camera when implemented.

The input/output interface 150 may receive data corresponding to a user's voice. For example, the input/output interface 150 may receive voice data from a microphone voice disposed in an upper side, a front direction, a side direction, or the like of the electronic apparatus 100′. Although the microphone is positioned outside the electronic apparatus in the above description, it may be an internal component of the electronic apparatus.

When the user's voice is input, the processor 140 may check the user's voice content, and perform an operation corresponding to the voice content. For example, the voice content here may be a request for information on a person appearing in the corresponding content or a request for information on a person currently displayed on the screen.

Although it is described above that the user's voice is input from the side of the electronic apparatus, the microphone may be equipped in the UWB device 10 (or remote controller) for controlling the electronic apparatus 100′, and the user's voice input through the microphone equipped in the remote controller may be input to the electronic apparatus 100′ and processed through the communicator 110 described above.

The electronic apparatus 100′ may not only operate based on the configuration provided in the electronic apparatus 100′ or the remote controller, but may also operate according to the control command of a terminal device. For example, when the electronic apparatus is a TV or a set-top box, each manufacturer has recently provided an application for controlling the TV or set-top box. Such an application may provide a function that allows the terminal device to be used as a remote controller for the electronic apparatus.

Therefore, when a user executes an application to control a TV or set-top box using a terminal device and the user inputs a voice command through the terminal device, the electronic apparatus 100′ may perform a voice recognition operation and a corresponding voice recognition result using a voice signal input through the terminal device.

The display 160 may be implemented as various types of displays, such as liquid crystal displays (LCDs), organic light emitting diodes (OLEDs) displays, plasma display panels (PDPs), projections, and the like. The display 160 may also include a driving circuit, a backlight unit, and the like, which may be implemented in the form of a-si TFTs, low temperature poly silicon (LTPS) TFTs, organic TFTs (OTFTs), and the like inside the display 160. The display 160 may be implemented as a touch screen combined with a touch sensor, a flexible display, a three-dimensional (3D) display, and the like.

The display 160 may display various images. For example, the display 160 may display an image or the like generated by the processor 140. Such an image may be an image in which a specific object is located at a location of a body part of the user recognized in the above process.

The speaker 170 may output sound. Specifically, the speaker 170 may be configured to output not only various audio data processed by the input/output interface but also various notification sounds, voice messages, etc.

For example, speaker 170 may output sound corresponding to a user's gesture. In this case, the processor 140 may output sound in a sound setting corresponding to the user's gesture.

In FIG. 3, it is illustrated and described that the electronic apparatus 100 includes the display 160, but when the electronic apparatus 100′ is a device such as a set-top box that does not include a display, the configuration of the display may be omitted. Also, depending on the implementation type, the electronic apparatus 100′ may not include the above-described speaker as well. In addition, the electronic apparatus may further include other configuration (e.g., a microphone, a human body detection sensor), etc.

FIG. 4 is a view provided to explain a method of obtaining a location using both a UWB signal and object recognition information according to one or more embodiments.

Referring to FIG. 4, preprocessing is performed on information (410) obtained through a UWB communication scheme and information (420) obtained through a camera (430). Specifically, when a signal is transmitted and received with an external electronic device through a UWB communication scheme, location information with respect to the external electronic device may be received through transmission of the corresponding signal. In addition, the camera may obtain an image in a preset period unit, and obtain image data from the camera in the above-described period unit. When implemented, the update period of the location information through the above-described UWB communication and the update period of the above-described camera image may be different from each other.

Hereinafter, it is assumed that a signal is received through one UWB and one camera, but in actual implementation, a signal may be received from a plurality of UWB devices, and an image may be received from a plurality of cameras rather than one.

As described above, since the update periods of the two sources used for identifying the location information are different, the electronic apparatus performs preprocessing on the two obtained signals. Such preprocessing may include verifying whether the received signal is within an expected range, and determining information to be used in a signal matching process described below when the periods of the two information are different.

First, whether the signal is deviating is to determine whether the input signal period at a specific time point significantly deviates from the known signal period. When it is determined to deviate significantly, instead of using the input signal value, a different value may be calculated and used. For example, previous data may be used and input to a regression equation, and a current value may be calculated and used. Alternatively, it may be obtained by using a Kalman filter or by inputting previous data into a pre-trained machine learning model.

In addition, during preprocessing, when the input signal value at the corresponding time significantly deviates from the existing signal values, it may be determined as an abnormal value of the signal and the value can be corrected. For example, when there is a physically impossible distance difference between the previous location value and the current location value, there is a very high possibility that the corresponding input signal is incorrect. Therefore, the electronic apparatus identifies whether such a situation has occurred, and if such a situation is confirmed, may calculate (e.g., interpolate) and use an expected value at the current time point using the previous data of each signal, use only the value of the Kalman filter, or input into a machine learning model to obtain it.

For such an operation, as described below, the operation result in the previous step may be stored in a database (DB) or the like (495), and the stored value may be used in the preprocessing process.

As such, when the preprocessing operation is completed, range detection (450) using an input UWB signal, object recognition (440) using an image signal, and candidate designation (460) using the same may be performed.

First, the range detection is a step of determining whether a signal input through preprocessing is a valid signal (or valid information). For example, the UWB range detection works with the camera to calculate the range of UWB signals that can be captured by the camera. In this process, a margin of about 10% outside the camera range can be determined as the valid signal range for interacting with the display.

The object recognition is to select an area where the user's hand is likely to be located or where a remote controller is likely to be located (440). For example, when the image can be divided into multiple boxes, the possibility of the hand or the remote controller being located in each box may be identified, and only boxes with a probability of 0.5 or higher can be selected as candidates.

The candidate designation is a step of identifying the user's hand area and the hand area holding the remote controller (460). For example, in the object recognition process, based on the location information identified from the UWB signal among the areas (or boxes) identified as areas where the hand or the remote controller is likely to be located, the box where the actual remote controller is located and the opposite hand corresponding to the box may be identified. For example, through this process, features and box information for p valid UWB signals, q valid user hands, and r valid remote controllers may be obtained.

The signals are combined based on the obtained location information (470). Specifically, a combining step may be performed to receive information generated in the previous process and match the timing of signals by considering different periods and delays between heterogeneous signals.

For example, first, the signal delay identified using the matching algorithm result of the DB may be reflected. If there is a signal for which the delay is not confirmed, the signal may not be reflected and instead, the input time range of the matching algorithm may be increased.

When the delay correction is completed, the period of the signals may be analyzed to select the optimal time points with the smallest signal uncertainty of the entire system. For example, the signal uncertainty at a certain time point may be calculated as a value proportional to the time from the corresponding time point to the more recent signal and the amount of change of the corresponding signal. In addition, the signal uncertainty of the entire system for the corresponding time point may be obtained by adding the signal uncertainty values of all related signals.

Further, each signal may be shifted to optimal time points. Such a shift process may use a known interpolation method, or location information stored in the memory may be used for signal interpolation.

Subsequently, matching may be performed (480). Specifically, this is a step of identifying, using the UWB signal where main time points are matched, user's hand information, and remote control information, who holds which UWB remote controller, which user uses a remote controller without UWB, and whether there is an interaction with the screen without a remote controller.

For example, user box information and remote control box information may be decoded and mapped to a three-dimensional space where a UWB signal is located. For example, for p UWBs, q user hand locations, and r remote control locations, signals from time t to time t-T may be collected and Dynamic Time Warping (DTW) algorithm may be applied to obtain matching cost matrices P, Q, and R of sizes p×q, q×r, and r×p. The matching cost matrices obtained in this way may represent the temporal and spatial mismatch between signal sequences of length T.

Hungarian algorithm may be applied to each P, Q, and R matrix, but dustbin may be added to each dimension to perform allocation between (p+1)×(q+1), (q+1)×(r+1), and (r+1)×(p+1) signals.

In addition, the matching obtained from the P matrix may be combined with the matching of the Q matrix to obtain matching for (p+1)×(r+1) and among these results, after comparing with the matching obtained from the R matrix, only the cyclically invariant matching whose results match may be taken.

When the above-described information is obtained through such matching, the obtained information (i.e., the user's left or right hand location information) may be stored in the memory (495). The information stored in this way may be used for signal preprocessing or signal combination process.

Subsequently, a reaction between a device and a use, i.e., an interaction is performed (490). For example, using the data paired through the matching algorithm, a response (or event) appropriate for each situation may be generated.

For example, when the user is enjoying game content, the electronic apparatus may display a sword object corresponding to the hand holding the remote controller and a shield object corresponding to the hand not holding the remote controller. Alternatively, the electronic apparatus may generate an image in which the hand holding the remote controller is displayed as a bowstring object and the hand not holding the remote controller is displayed as holding a bow.

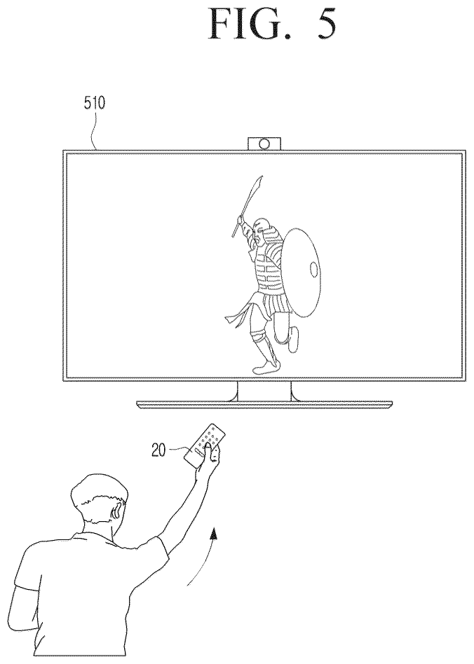

FIG. 5 is a view provided to explain an operation for identifying left/right hands of a user according to one or more embodiments.

Referring to FIG. 5, the electronic apparatus may execute game content in which a character moves in response to the user's movement. For this execution, the electronic apparatus may photograph the user located in front and may identify the movement of a specific body part (e.g., right hand and left hand) in the photographed image.

For example, when the movement of a specific hand is identified as shown in the drawing, the right hand of a specific object in the image may be made to move in response to the user's movement.

In such game content, it may operate in response to the reaction of both the user's left and right hands. In other words, when the user moves the opposite hand (e.g., left hand) that does not hold the remote controller, the electronic apparatus may cause the shield of a specific object in the game image to move in response to the movement of the corresponding left hand.

In such a process, the electronic apparatus may more precisely identify the movement of the user's specific hand based on the location information of the UWB signal obtained from the remote controller held by the user, and may also determine how the main object of a specific object in the image will be expressed.

For example, as shown in the drawing, when the user holds the remote controller with his or her right hand, a specific object in the image may be made to hold a weapon (e.g., a sword) in his right hand. Conversely, when the user holds the weapon with the left hand, a specific object in the image may hold the weapon with the left hand.

Such an operation may be performed while the image is in progress. For example, when the user moves the remote controller from the right hand to the left hand on the screen as shown in FIG. 5, the object in the image may switch the location of the weapon and shield accordingly.

In the present disclosure, since the above-described location may be obtained using a UWB signal, it is possible to more accurately display the moving direction of a specific object in the image. For example, when photographing the user with a general camera, the user's hand movement in the image is recognized in two dimensions, and this is modeled and used in three dimensions. During this process, it is difficult to identify precise movements, but since the location using the UWB scheme may use the movement information in the 3D space as it is, it is possible to obtain precise movement information.

In addition, even if the recognition of the hand in the image is not well performed because it is dark or the color difference from the background is not large, using location information measured by the UWB scheme can have a higher recognition rate or reactivity.

Since the location information for the UWB scheme is more accurate than the location information using an image as described above, it may be considered to perform interaction only with communication with the UWB device without using images. However, in this case, a UWB device corresponding to the number of each moving object is required. In other words, when an image is used as described in the drawing, interaction corresponding to both the left and right hands is possible even if one UWB device is used, but there is a limitation that only one movement can be used by using only the UWB device.

In addition, when it is necessary to distinguish the user's hand, it is difficult to distinguish when using only the UWB device, but according to the present disclosure, the user may identify the hand holding the remote controller based on the image.

However, as described above, when it is necessary to identify only the movement of one location (e.g., displaying a mouse cursor), it is possible to use only the location information using UWB signals without using images.

In addition, it is possible to change the information used according to the time period, such as using only the location information of the UWB device in a specific section, using only the location information of the image in another section, or using both information in a specific other section.

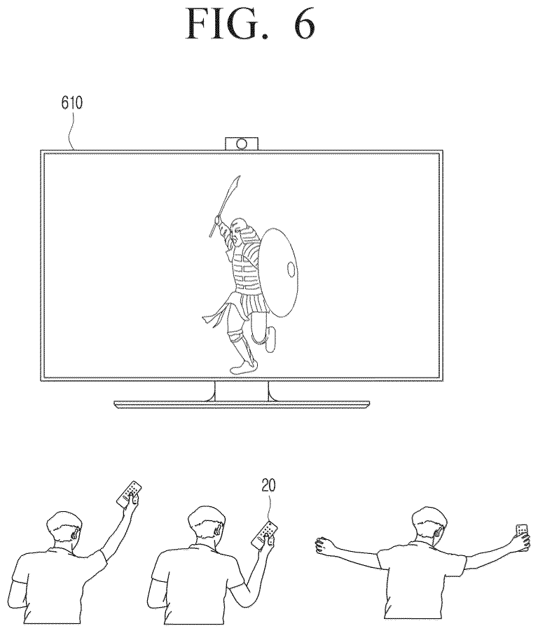

FIG. 6 is a view provided to explain an operation for identifying a user to perform object recognition among a plurality of users according to one or more embodiments.

Referring to FIG. 6, a plurality of users are located in the same environment as in FIG. 5, but in front of the electronic apparatus. As such, when a plurality of users are located, if the movement of the user's body position is confirmed using only the image, it is unclear which user's body position the electronic apparatus should operate in response to.

When all the movements of each user are reflected accordingly, the user who actually proceeds with the game may be less immersed in the progress of the game.

However, in this disclosure, since the user who holds the UWB device can be identified and interaction is carried out using only the hand information of the user, more accurate operation is possible.

FIG. 7 is a diagram a UWB positioning operation according to one or more embodiments.

Referring to FIG. 7, a TWR scheme among the operation schemes of the location in the UWB communication scheme is illustrated.

The UWB may determine its location through ToF. This allows for accurate measurement of the distance between transmission and reception by calculating the time it takes for a signal to travel between devices, and can also detect X, Y, Z coordinates of the device location. The present disclosure uses the detection technology of X, Y, Z coordinates (e.g., the location value of device B at a fixed location A) in the UWB.

UWB positioning may use two basic techniques: Time Difference of Arrival (TDoA) and Two-way Ranging (TWR). Here, the TDoA is a method of detecting and locating a UWB device using a UWB anchor or sensor placed at a fixed location throughout the indoor space.

The TWR is a method of measuring distance using two-way communication between two devices. Such a TWR scheme has the advantage of not requiring time synchronization between the two devices. Specifically, the two devices (10, 100) may measure distance by exchanging three messages (POLL, Response, Final) as shown in FIG. 7.

First, the UWB device 10 transmits a poll message toward the electronic apparatus 100 (710). When such a poll message is transmitted, the TWR operation is initialized.

In addition, the second electronic apparatus 100 receiving the poll message may record the time when the poll was received and respond with a response message (720).

The UWB device 10 receiving the response message may transmit the time information in the above-described process to the electronic apparatus 100 as a final message. For example, the final message may transmit transmission time information (T_{SP}) of the poll message, time information (T_{RR}) when the response message is received, and time information (T_{SF}) when the UWB device 10 transmits the final message.

The second electronic apparatus receiving the final message as described above may determine the ToF with respect to the first electronic apparatus and the distance between them based on the reception time of the final message. For example, the time for a signal to be transmitted between the two devices can be multiplied by the speed of light to determine the relative location.

Thanks to the fast nanosecond pulse that can be detected through ToF and limited interference with other RF transmission, such UWB communication can track indoor location with accuracy of less than 50 cm, and the movement and operation of a device can be tracked quickly with real-time results.

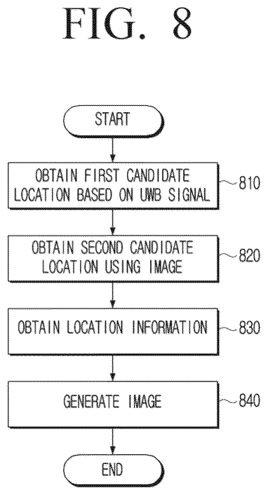

FIG. 8 is a flowchart of a controlling method of an electronic apparatus according to one or more embodiments.

Referring to FIG. 8, the electronic apparatus obtains a first candidate location corresponding to the location of the UWB device based on a signal received from another electronic apparatus through an Ultra Wide-Band (UWB) scheme (810).

When implemented, verification of the obtained information may be performed. For example, by comparing the stored location information with the obtained first candidate location, the electronic apparatus may obtain the first candidate location based on the stored location information when the location corresponding to the stored location information is equal to or greater than a preset distance. Alternatively, when the reception period of the image is shorter than the signal reception period with the UWB device, the electronic apparatus may obtain the first candidate location corresponding to the current time based on the stored location information and the previously obtained first candidate location.

The electronic apparatus obtains a second candidate location corresponding to a preset object in the image based on the received image (820). For example, the electronic apparatus may identify whether the obtained candidate location is a location in the image, and may obtain the second candidate location based on the identification result. For example, the electronic apparatus may recognize the first hand and the second hand of the user in the image based on the image, and may obtain the second candidate location by identifying the hand holding the UWB device among the first hand or the second hand based on the first candidate location.

When a plurality of users are included in the image, the electronic apparatus may first identify the user holding the UWB device among a plurality of users based on the first candidate location and obtain the second candidate location based on the identified user's hand.

It is assumed above that there is only one UWB device, and if there are a plurality of other electronic apparatuses (i.e., UWB devices), and a plurality of users hold each UWB device individually, the user holding each UWB device can be individually identified.

For the above identification, the first candidate location in the current step may be used, or location information identified and stored in the previous step may be used.

The electronic apparatus obtains location information of the user's body holding the UWB device based on the obtained first candidate location and the second candidate location (830). The location information obtained as described above may be stored together with time information.

The electronic apparatus generates an image based on the obtained location information (840). For example, when the locations of the first hand holding the UWB device and the second hand that does not are obtained, an image that displays a first object in the first hand location and a second object different from the first object in the second hand location may be generated.

Alternatively, a user's gesture may be identified based on the above-described location information, and an event corresponding to the identified user's gesture may be performed.

As described above, the controlling method according to the present disclosure identifies the user's body area by using the UWB signal and the image together, so that even when it is difficult to identify accurate movement using the image alone, accurate movement confirmation is possible.

The methods according to at least some of the above-described various embodiments may be implemented in a form of an application that can be installed in the existing electronic apparatuses.

In addition, the methods according to at least some of the above-described various embodiments may be implemented by software upgrade to the existing electronic apparatuses, or by hardware upgrade alone

Further, the methods according to at least some of the above-described various embodiments may also be performed through an embedded server provided in the electronic apparatuses or at least one external server among the electronic apparatuses.

The above-described various embodiments may be implemented as software including instructions stored in machine-readable storage media, which can be read by machine (e.g.: computer). The machine may be a device that invokes the stored instruction from the storage medium and can be operated based on the invoked instruction, and may include an electronic device (e.g.: electronic apparatus (A)) according to the embodiments disclosed herein. In case that the instruction is executed by the processor, the processor may directly perform a function corresponding to the instruction or other components may perform the function corresponding to the instruction under control of the processor. The instruction may include codes generated or executed by a compiler or an interpreter. The machine-readable storage media may be provided in a non-transitory storage medium. Here, ‘non-transitory storage medium’ merely means that the storage medium is tangible without including a signal (e.g. electromagnetic waves), and does not distinguish whether data are semi-permanently or temporarily stored in the storage medium. For example, the ‘non-transitory storage medium’ may include a buffer in which data is temporarily stored. According to one or more embodiments, the methods according to one or more embodiments may be included and provided in a computer program product. The computer program product may be traded as a product between a seller and a purchaser. The computer program product may be distributed in the form of a storage medium (e.g., compact disc read only memory (CD-ROM)) that is readable by devices, may be distributed through an application store (e.g., PlayStore™) or directly between two user devices (e.g., smartphones), or may be distributed online (e.g., by downloading or uploading). In the case of an online distribution, at least part of the computer program product (e.g., a downloadable application) may be at least temporarily stored in a storage medium readable by a machine such as a server of the manufacturer, a server of an application store, or the memory of a relay server or may be temporarily generated.

The various embodiments may be implemented as software including instructions stored in machine-readable storage media, which can be read by machine (e.g.: computer). The machine refers to a device that calls instructions stored in a storage medium, and can operate according to the called instructions, and the device may include an electronic apparatus (e.g.; electronic apparatus (A)) according to the aforementioned embodiments.

In case where the above-described instruction is executed by a processor, the processor may perform a function corresponding to the instruction by itself, or by using other components under its control. The instruction may include a code that is generated or executed by a compiler or an interpreter.

Although certain example embodiments of the present disclosure have been shown and described above, the disclosure is not limited to the specific embodiments described above, and various modifications may be made by one of ordinary skill in the art without departing from the gist of the disclosure as claimed in the claims, and such modifications are not to be understood in isolation from the technical ideas or prospect of the disclosure.

What is claimed is:

1. An electronic apparatus comprising:
a sensor;
a communicator configured to receive an Ultra Wide-Band (UWB) signal;
memory storing at least one instruction; and
at least one processor operatively connected to the sensor, the communicator, and the memory,
wherein the at least one instruction, when executed by the at least one processor individually or collectively, causes the electronic apparatus to:
obtain a first candidate location corresponding to a location of an external device, based on the UWB signal received by the communicator;
based on a first image obtained through the sensor, obtain a second candidate location corresponding to at least one body part in the first image;
obtain location information of a user body part of a user corresponding to the external device based on the first candidate location and the second candidate location; and
generate a second image based on the location information.

2. The electronic apparatus as claimed in claim 1, wherein the at least one instruction, when executed by the at least one processor individually or collectively, further causes the electronic apparatus to:
recognize a first hand and a second hand of a user as the at least one body part in the first image; and
obtain the second candidate location by identifying a hand that grips the external device among the first hand and the second hand, based on the first candidate location.

3. The electronic apparatus as claimed in claim 2, wherein a first object is displayed at a location corresponding to the first hand and a second object different from the first object is displayed at a location corresponding to the second hand in the second image.

4. The electronic apparatus as claimed in claim 2, wherein the at least one instruction, when executed by the at least one processor individually or collectively, further causes the electronic apparatus to, based on recognizing a plurality of users based on the first image, identify a user gripping the external device among the plurality of users based on the first candidate location, and obtain the second candidate location based on the hand that grips the external device.

5. The electronic apparatus as claimed in claim 1, wherein the at least one instruction, when executed by the at least one processor individually or collectively, further causes the electronic apparatus to:
store the location information and time information in the memory; and
identify the user body part based on the location information stored in the memory, and obtain the second candidate location based on the user body part.

6. The electronic apparatus as claimed in claim 5, wherein the at least one instruction, when executed by the at least one processor individually or collectively, further causes the electronic apparatus to:
compare the location information stored in the memory and the first candidate location; and
based on the first candidate location and a location corresponding to the stored location information being equal to or greater than a preset distance, obtain the first candidate location based on the location information stored in the memory.

7. The electronic apparatus as claimed in claim 5, wherein the at least one instruction, when executed by the at least one processor individually or collectively, further causes the electronic apparatus to, based on a reception period of the first image being shorter than a reception period of the UWB signal from the external device, obtain the first candidate location corresponding to a current time point based on the location information stored in the memory and a most recently obtained first candidate location.

8. The electronic apparatus as claimed in claim 5, wherein the at least one instruction, when executed by the at least one processor individually or collectively, further causes the electronic apparatus to:
identify a user gesture based on the location information stored in the memory and the location information that is obtained; and
perform an event corresponding to the user gesture.

9. The electronic apparatus as claimed in claim 1, wherein the at least one instruction, when executed by the at least one processor individually or collectively, further causes the electronic apparatus to:
obtain a user pose based on the first image; and
obtain the location information based on the user pose and the first candidate location.

10. The electronic apparatus as claimed in claim 1, wherein the at least one instruction, when executed by the at least one processor individually or collectively, further causes the electronic apparatus to identify whether the first candidate location is within the first image, and obtain the second candidate location based on whether the first candidate location is within the first image.

11. A method of controlling an electronic apparatus, the method comprising:
obtaining, based on an Ultra Wide-Band (UWB) signal received from an external device, a first candidate location corresponding to a location of the external device;
obtaining a second candidate location corresponding to at least one body part in a first image;
obtaining location information of a user body corresponding to the external device based on the first candidate location and the second candidate location; and
generating a second image based on the location information.

12. The method as claimed in claim 11, wherein the obtaining the second candidate location comprises recognizing a first hand and a second hand of a user as the at least one body part in the first image, and obtaining the second candidate location by identifying a hand that grips the external device among the first hand and the second hand, based on the first candidate location.

13. The method as claimed in claim 12, wherein a first object is displayed at a location corresponding to the first hand and a second object different from the first object is displayed at a location corresponding to the second hand in the second image.

14. The method as claimed in claim 12, wherein the obtaining the second candidate location comprises, based on recognizing a plurality of users based on the first image, identifying a user gripping the external device among the plurality of users based on the first candidate location, and obtaining the second candidate location based on the hand that grips the external device.

15. The method as claimed in claim 11, further comprising:
storing the location information and time information in the memory; and
identifying the user body part based on the stored location information, and obtaining the second candidate location based on the user body part.

16. The method as claimed in claim 15, further comprising:
comparing the stored location information and the first candidate location; and
based on the first candidate location and a location corresponding to the stored location information being equal to or greater than a preset distance, obtaining the first candidate location based on the stored location information.

17. The method as claimed in claim 15, further comprising:
based on a reception period of the first image being shorter than a reception period of the UWB signal from the external device, obtaining the first candidate location corresponding to a current time point based on the stored location information and a most recently obtained first candidate location.

18. The method as claimed in claim 15, further comprising:
identifying a user gesture based on the stored location information and the location information; and
performing an event corresponding to the user gesture.

19. The method as claimed in claim 11, further comprising:
obtaining a user pose based on the first image; and
obtaining the location information based on the user pose and the first candidate location.

20. A non-transitory computer recording medium storing a program for executing a method of controlling an electronic apparatus, the method comprising:
obtaining, based on an Ultra Wide-Band (UWB) signal received from an external device, a first candidate location corresponding to a location of the external device;
obtaining a second candidate location corresponding to at least one body part in a first image;
obtaining location information of a user body part corresponding to the external device based on the first candidate location and the second candidate location; and
generating a second image based on the location information.
